(19) United States
(12) Patent Application Publication
(10) Pub. No.: US 2012/0280184 A1
(43) Pub. Date: Nov. 8, 2012

(54) Composite Material of Electroconductor Having Controlled Coefficient of Thermical Expansion

(75) Inventors: Ramon Torrecillas San Millan, Oviedo (ES); Olga Garcia Moreno, Aviedo (ES); Maria Amparo Borrell Tomás, Oviedo (ES); Adolfo Fernández Valdes, Coruno - Llanera (ES)

(73) Assignee: Consejo Superior De Investigaciones Cientificas (CSIC), Madrid (ES)

(21) Appl. No.: 13/516,212

(22) PCT Filed: Dec. 14, 2010
(86) PCT No.: PCT/ES2010/070827

§ 371 Date: Jul. 26, 2012

(30) Foreign Application Priority Data
Dec. 16, 2009 (ES) P 200931176

(51) Int. Cl. H01B 1/04; C04B 35/645; B82Y 30/00; B82Y 40/00

(52) U.S. Cl. 252/504; 264/604; 252/502; 252/508; 252/506; 252/507; 977/734; 977/773; 977/900

(57) ABSTRACT

The present invention relates to a composite material comprising a ceramic component, characterized in that it has a negative coefficient of thermal expansion, and carbon nanofilaments, to its obtainment process and to its uses as electrical conductor in microelectronics, precision optics, aeronautics and aerospace.

The present invention relates to a composite material comprising a ceramic component, characterized in that it has a negative coefficient of thermal expansion, and carbon nanofilaments, to its obtainment process and to its uses as electrical conductor in microelectronics, precision optics, aeronautics and aerospace.

### PRIOR ART

Materials with low coefficient of thermal expansion (CTE) have a broad range of applications in very different fields. These types of materials are required in many types of precision apparatus and in instrumentation equipment in high-technology systems, in the microelectronics industry and precision optics. In short, in all those applications wherein dimensional stability has to be guaranteed of a precision element with changes in temperature, which makes it necessary to decrease the CTE of the materials that form these elements. The imbalance in the thermal expansion in elements manufactured with different materials may also be resolved using the design of composites with a required (and homogeneous) CTE. The design of these materials with tailored CTE can be tackled using the combination of components with positive and negative expansion. This tailored design of the composites' CTE can be carried out for different temperatures, so that the final field of application of the components with zero CTE will depend on whether the other characteristics that the specific functionality for that application requires are achieved. The family of lithium ceramics and glass-ceramics (LAS) and magnesium aluminosilicates (cordierite) are frequently used for this purpose in many fields of application, from glass-ceramics for kitchens to mirrors for satellites. Some mineral phases of this family have a negative CTE which allows their use in composites with controlled and tailored CTE. Frequently, materials with negative CTE have a low resistance to fracture, since their negativity is due to a strong anisotropy between the different crystallographic orientations, wherein negative behaviour is usually found in one of them and positive behaviour in the other two. Anisotropy usually causes microfissures which give the result of low values in the mechanical properties of these materials. Therefore, the addition of oxidic/non-oxidic ceramic phases enables obtaining materials with improved mechanical properties. These materials with controlled CTE are interesting for applications in engineering, photonics, electronics and/or structural (Roy, R. et al., Annual Review of Materials Science, 1989, 19, 59-81).

The phase with negative expansion in the LAS system is β-eucryptite (LiAlSiO₄), due to the great negative expansion in the direction of one of its crystallographic axes. The spodumene (LiAlSi₂O₆) and petalite (LiAlSi₄O₁₀) phases have CTEs close to zero. The traditional method of manufacturing materials with LAS composition is the processing of glasses to produce glass-ceramics. This method involves the forming of glass to later apply a heat treatment at lower temperatures for the subsequent precipitation of crystalline LAS phases and thus control its CTE. On occasions this process produces heterogeneous materials and, of course, as it is glass, its mechanical properties (rigidity and resistance) are not sufficiently high for many industrial applications compared with other ceramic ones. This is the case of Zerodur® (marketed by Schott) widely used in a multitude of applications but with too low resistance to fracture values. An alternative to glass-ceramics is, therefore, necessary if better mechanical properties are required. There are other ceramic materials with CTE close to zero such as cordierite as disclosed in U.S. Pat. No. 4,403,017 or Invar®. An alternative to the preparation of materials with low CTE consists of the addition of a second phase with positive coefficient of thermal expansion to a ceramic component whose CTE is negative, as in the cases U.S. Pat. No. 6,953,538, JP2007076949 or JP2002220277, and patent application P200803530. This last option is very interesting and the value of the CTE and the other properties can be adjusted by the addition of the suitable proportions of second phases in the matrix. On the other hand, and bearing in mind that the end properties of the material are a consequence of the combination of two or more components, the main problem of these composites lies in managing to control the value of the CTE for a wide temperature range. Thus, in U.S. Pat. No. 6,953,538, JP2007076949 or JP2002220277, the temperature ranges wherein high dimensional stability is achieved are approximately 30-50° C. In patent application P200803530 the temperature range for a value of CTE close to zero is expanded.

In patent P200803530, magnesium (cordierite) and lithium aluminosilicates are used. Patent with application number P200803530 discloses a method of lithium aluminosilicate synthesis from kaolin, lithium carbonate and precursors of silica and alumina in solution whereby it is possible to obtain LAS ceramics with a controlled CTE and a la carte, choosing different compositions within the Al₂O₃Li₂O:SiO₂ phase diagram

### DESCRIPTION OF THE INVENTION

The present invention provides a composite material comprising a ceramic matrix and carbon nanofilaments, said material being characterized in that it has excellent mechanical, electroconductive and thermal properties. The present invention also provides an obtainment process of the material, and its uses as electrical conductor in the manufacturing of instruments for microelectronics, precision optics, aeronautics and aerospace.

A first aspect of the present invention relates to a material comprising:
a. A ceramic component, and
b. carbon nanofilaments,
   where said material has a coefficient of thermal expansion between −6×10⁻⁶° C.⁻¹ and 6.01×10⁻⁶° C.⁻¹.

This material is a composite material, and these carbon nanofilaments act as electrical conductors; furthermore, they are the reinforcement in the ceramic matrix (with negative coefficient of thermal expansion) of the material disclosed in the present invention. Which makes this material electroconductive.

In the present invention, “composite material” is understood as materials formed by two or more components that can be distinguished from one another, they have properties obtained from the combinations of their components, being superior to the materials formed separately.

The ceramic component, in the present invention, is going to act as matrix of the composite material, therefore being a ceramic matrix.

In the present invention “electroconductive” is understood as the material with the capacity of allowing the passage of electric current or electrons therethrough.

In the present invention “coefficient of thermal expansion” (CTE) is understood as the parameter reflecting the variation in the volume undergone by a material when it is heated.

The material in a preferred embodiment is characterized in that it further contains an oxidic or non-oxidic ceramic compound in a volume percent less than 80%.

The ceramic component is preferably selected from the Li₂O:Al₂O₃:SiO₂ system or the MgO:Al₂O₃:SiO₂ system, this matrix being more preferably β-eucryptite or cordierite.

The ceramic component, with negative coefficient of thermal expansion, in a preferred embodiment has a proportion with respect to the end material greater than 10% by volume.

The carbon nanofilaments that act as reinforcement contained in the matrix may be carbon nanofibres or nanotubes, in a preferred embodiment being carbon nanofibres, these carbon nanofibres more preferably having a diameter between 20 and 80 nm, the length/diameter ratio is more preferably greater than 100 and it more preferably has a graphitic structure greater than 70%.

In the present invention, “carbon nanofibres” are understood as carbon filaments with a highly graphitic structure.

The oxidic or non-oxidic ceramic is preferably selected from carbides, nitrides, borides, oxides of metal or any of their combinations. More preferably the oxidic or non-oxidic ceramic is selected from the list comprising: SiC, TiC, AlN, Si₃N₄, TiB₂, Al₂O₃, ZrO₂ and MgAl₂O₄.

The oxidic ceramic is even more preferably Al₂O₃ with a grain size of alumina (Al₂O₃) more preferably between 20 and 1000 nm. And if the ceramic is non-oxidic it is more preferably SiC; even more preferably this silicon carbide selected has a grain size less than 10 μm.

Controlling the reactivity at a high temperature between the phases composing the composite material, and controlling the CTE of the composites so that electroconductive ceramic materials can be created with CTE, depending on the application one wants to give to the material, in a wide range of temperatures. The advantages of using, on the one hand, an electroconductive phase in these composites lies in the possibility of obtaining materials with a high electrical conductivity, maintaining the CTE and low density, on the other hand, the oxidic/non-oxidic ceramics enable obtaining materials with improved mechanical properties.

The electroconductive composite material with ceramic matrix is characterized in that it has a controlled dimensional stability, characterized in that it contains carbon nanofilaments in its composition and the composition of said ceramic matrix has a negative coefficient of thermal expansion, and may have a porosity less than 10 vol % with a value of electrical resistivity less than 1×10⁴ Ωcm, a coefficient of thermal expansion adjusted in accordance with the composition between −6×10⁻⁶° C.⁻¹ and 6.01×10⁻⁶° C.⁻¹ in the temperature range between −150° C. and 450° C., a resistance to fracture greater than 60 MPa and a low absolute density.

A second aspect of the present invention relates to an obtainment process of the material as previously described, comprising the stages:
a. Mixing of the ceramic component with the carbon nanofilaments in a solvent,
b. drying of the mixture obtained in (a),
c. forming of the material obtained in (b),
d. sintering of the material obtained in (c).

In a preferred embodiment an oxidic or non-oxidic ceramic is added in stage (a) as previously explained.

The solvent used in stage (a) is selected from water, anhydrous alcohol or any of their combinations, and even more preferably the anhydrous alcohol is anhydrous ethanol.

The mixing of stage (a) is performed preferably between 100 and 400 r.p.m. This mixing can be performed in an attrition mill. The drying of stage (b) in a preferred embodiment is performed by atomization.

In the present invention “atomization” is understood as a method of drying by the pulverization of solutions and suspensions with an airstream.

The forming of stage (c) is performed preferably by cold isostatic pressing or by hot pressing.

In the present invention “isostatic pressing” is understood as a compacting method which is performed by hermetically enclosing the material, generally in the form of powder, in moulds, applying a hydrostatic pressure via a fluid, the parts thus obtained have uniform and isotropic properties.

When the cold isostatic pressing is performed it is more preferably performed at pressures between 100 and 400 MPa.

If a hot pressing is performed, an uniaxial pressure is applied between 5 and 150 MPa, at a temperature between 900 and 1600° C., with a heating ramp between 2 and 50° C./min, remaining at this temperature for 0.5 to 10 hours.

The sintering temperature of stage (d) is preferably between 700 and 1600° C. Stage (d) of sintering can be performed without the application of pressure or applying uniaxial pressure.

When it is performed without applying pressure, the sintering can be performed in a conventional oven, whilst when a uniaxial pressure is applied during the sintering it can be performed by Spark Plasma Sintering (SPS) or Hot-Press.

When the sintering is performed without application of pressure it is performed in an inert atmosphere at a temperature between 1100 and 1600° C., with a heating ramp between 2 and 10° C./min, remaining at this temperature for 0.5 and 10 hours. Even more preferably the inert atmosphere is of argon.

With the possibility of even more preferably using subsequent cooling to 900° C. using a ramp of between 2 and 10° C./min.

If the sintering using the application of uniaxial pressure is performed by applying a uniaxial pressure between 5 and 150 MPa, at a temperature between 700 and 1600° C., with a heating ramp of between 2 and 300° C./min, remaining at this temperature for a period between 1 and 30 min. This method of sintering enables obtaining materials with controlled grain size using short periods of time.

The preparation is carried out by a simple manufacturing process, which is formed and sintered in solid state by different techniques, avoiding the formation of glasses and, in consequence, achieving improved mechanical properties.

If a matrix of lithium or magnesium aluminosilicates has been chosen with an electroconductive phase with the possibility of adding a third oxidic or non-oxidic phase, without there being any reaction between the phases at high temperatures, in this way it improves the mechanical, electrical and thermal properties, simplifying the obtainment process, achieving a dense, whilst ultralight, material. This control is due to the use of the phases with negative CTE in particular.

The alternative presented in the present invention is the obtainment of ceramic materials that are electroconductive with a coefficient of thermal expansion controlled in a wide temperature range, which makes them adaptable to a multitude of mechanical applications, their low density (or light). In addition to being electrical conductors, it open up the possibility that these materials may be machined using electroerosion techniques to be able to prepare achieve obtain the components with the desired form.

A third aspect of the present invention relates to the use of the material as previously described, as an electrical conductor, and/or as material in the manufacturing of ceramic components with high dimensional stability. Said material is applicable in the sectors of microelectronics, precision optics or the aeronautical sector. In a preferred embodiment said electrical conductor material being used in the manufacturing of high-precision measuring instruments, mirrors for space observation systems, photolithography scanners, holography, laser instrumentation or heat dissipaters.

In short, these composite materials are used for the manufacturing of components that require high dimensional stability, and more specifically in the structure of mirrors in astronomic telescopes and X-ray telescopes in satellites, optical elements in comet probes, meteorological satellites and microlithography, mirrors and mounts in laser ring gyroscopes, laser distance indicators in resonance, measurement bars and standards in high-precision measurement technologies, etc.

Throughout the description and the claims the word “comprises” and its variants are not intended to exclude other technical characteristics, additives, components or steps. For persons skilled in the art, other objects, advantages and characteristics of the invention will be inferred in part from the description and in part from the practice of the invention. The following figures and examples are provided by way of illustration, and are not intended to limit the present invention.

### DESCRIPTION OF THE FIGURES

FIG. 1. Phase diagram of the Li₂O—Al₂O₃—SiO₂ system, showing the composition used in the examples of embodiment.

FIG. 2. Coefficients of thermal expansion (α curves) corresponding to the LAS materials-carbon nanofibres obtained by sintering in SPS, cordierite-carbon nanofibres obtained by conventional oven, LAS-carbon nanofibres-SiC obtained by hot-press sintering and LAS-carbon nanofibres-Al₂O₃ obtained by sintering in SPS.

### EXAMPLES

Below, the invention will be illustrated with assays performed by the inventors, which reveal the specificity and efficacy of the electroconductive composite material with controlled CTE in the range (−150, +450)° C. as a particular embodiment of the process object of the invention.

### Example 1

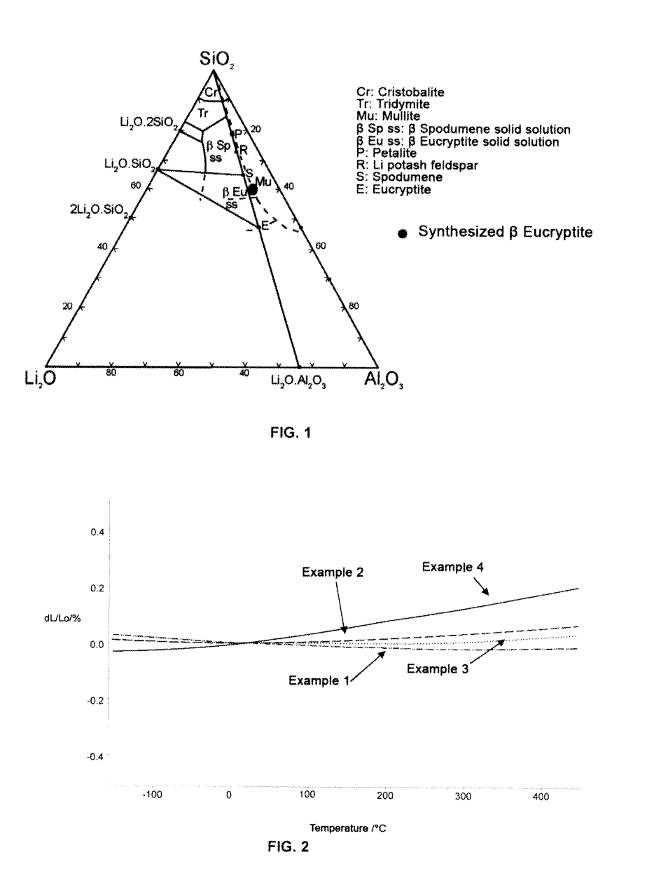

The starting materials are:
a) LAS powder with the composition LiAlSiO₄ (composition A in FIG. 1) with average particle size of 1 μm and density 2.39 g/cm³.
b) Carbon nanofibres, with diameters in the order of 20-80 nm and density 1.97 g/cm³.
c) Anhydrous ethanol (99.97% of purity).

700 g of LAS are used which were dispersed in 1400 g of ethanol. It is then mixed with a suspension of 146.4 g of carbon nanofibres in 2000 g of ethanol. The combination is homogenized by mechanical stirring during 60 minutes and is then milled in an attrition mill operating at 300 r.p.m. during a further 60 minutes. The suspension thus prepared is dried by atomization, obtaining nanocomposite granules whist recovering the ethanol from the process. The milling stage enables preparing a homogeneous powder and of nanometric size that improves the densification of the end material.

The dry product thus obtained was subjected to a forming and sintering process using Spark Plasma Sintering (SPS). For this, 14.5 grams of the material are introduced in a graphite mould with a diameter of 40 mm and it is uniaxially pressed at 10 MPa. Next, the sintering is carried out by applying a maximum pressure of 80 MPa, with heating ramp of 100° C./min to 1200° C. and 1 minute's stay.

The resulting material was characterized by its real density (helium pycnometry), apparent density (Archimedes' method), Young's modulus (resonance frequency method in a Grindosonic unit), resistance to fracture (four point bending method in an INSTRON 8562 unit), and coefficient of thermal expansion (dilatometer, make: NETZCH, model: DIL402C). The corresponding values appear in Table 1. The variation of the coefficient of thermal expansion with the temperature is represented in FIG. 2.

TABLE 1
Results obtained from the characterization of the composite
material of LAS and carbon nanofibres, sintering by SPS.

| Property | Ex. 1 |
|---|---|
| % Theoretical density | 99.8 |
| 100 × (dₐₚₚₐᵣₑₙₜ/Dᵣₑₐₗ) | |
| Resistance to fracture (MPa) | 165 |
| CTE(×10⁻⁶ ° C.⁻¹) (−150, 150) ° C. | −1.34 |
| CTE(×10⁻⁶ ° C.⁻¹) (−150, 450) ° C. | −0.69 |

### Example 2

The starting materials are:
a) Cordierite powder with the composition 2Al₂O₃.5SiO₂.2MgO with density 2.65 g/cm³.
b) Carbon nanofibres, with diameters in the order of 20-80 nm and density 1.97 g/cm³.
c) Anhydrous ethanol (99.97% purity).

900 g of cordierite were used which were dispersed in 1600 g of ethanol. It is then mixed with a suspension of 21 g of carbon nanofibres in 400 g of ethanol. The combination is homogenized by mechanical stirring during 60 minutes and is then milled in an attrition mill operating at 300 r.p.m. during a further 60 minutes. The suspension thus prepared is dried by atomization, obtaining nanocomposite granules whist recovering the ethanol from the process.

The dry product was subjected to a forming process using cold isostatic pressing at 200 MPa. A formed material is obtained which is sintered in a conventional oven in an argon atmosphere at 1400° C., with a stay of 120 minutes and heating ramp of 5° C./min.

The resulting material was characterized by its real density (helium pycnometry), apparent density (Archimedes' method), Young's modulus (resonance frequency method in a Grindosonic unit), resistance to fracture (four point bending method in an INSTRON 8562 unit), and coefficient of thermal expansion (dilatometer, make: NETZCH, model: DIL402C). The corresponding values appear in Table 2. The variation of the coefficient of thermal expansion with the temperature is represented in FIG. 2.

TABLE 2
Results obtained from the characterization of the composite material of
cordierite and carbon nanofibres, sintering in conventional oven.

| Property | Ex. 2 |
|---|---|
| % Theoretical density | 99.1 |
| 100 × (dₐₚₚₐᵣₑₙₜ/dᵣₑₐₗ) | |
| Resistance to fracture (Mpa) | 120 |
| CTE(×10⁻⁶ ° C.⁻¹) (−150, 150) ° C. | −0.02 |
| CTE(×10⁻⁶ ° C.⁻¹) (−150, 450) ° C. | 0.91 |

### Example 3

The starting materials are:
a) LAS powder with the composition LiAlSiO₄ (composition in FIG. 1) with average particle size of 1 μm and density 2.39 g/cm³.
b) Carbon nanofibres, with diameters in the order of 20-80 nm and density 1.97 g/cm³.
c) SIC powder with average particle size less than 100 nm and density 3.20 g/cm³.
d) Anhydrous ethanol (99.97% purity)

600 g of LAS were used which were dispersed in 1300 g of ethanol. It is then mixed with a suspension of 63 g of carbon nanofibres in 1100 g of ethanol and a suspension of 143.8 g of n-SiC in 1000 g of ethanol. The combination is homogenized by mechanical stirring during 60 minutes and is then milled in an attrition mill operating at 300 r.p.m. during a further 60 minutes. The suspension thus prepared is dried by atomization, obtaining nanocomposite granules whist recovering the ethanol from the process.

The dry product thus obtained was subjected to a forming and sintering process using Hot-Press. For this, 30 grams of the material are introduced in a graphite mould with a diameter of 50 mm and it is uniaxially pressed at 5 MPa. Next, the sintering is carried out by applying a maximum pressure of 35 MPa, with heating ramp of 5° C./min until 1150° C. and 120 minutes' stay. The resulting material was characterized by its real density (helium pycnometry), apparent density (Archimedes' method), Young's modulus (resonance frequency method in a Grindosonic unit), resistance to fracture (four point bending method in an INSTRON 8562 unit), and coefficient of thermal expansion (dilatometer, make; NETZCH, model; DIL402C). The corresponding values appear in Table 3. The variation of the coefficient of thermal expansion with the temperature is represented in FIG. 2.

TABLE 3
Results obtained from the characterization of the composite
material of LAS and carbon nanofibres, sintering by Hot-Press.

| Property | Ex. 3 |
|---|---|
| % Theoretical density | 98.8 |
| 100 × (dₐₚₚₐᵣₑₙₜ/dᵣₑₐₗ) | |
| Resistance to fracture (Mpa) | 144 |
| CTE(×10⁻⁶ ° C.⁻¹) (−150, 150) ° C. | −0.34 |
| CTE(×10⁻⁶ ° C.⁻¹) (−150, 450) ° C. | 0.35 |

### Example 4

The starting materials are:
a) LAS powder with the composition LiAlSiO₄ (composition in FIG. 1) with average particle size of 1 μm and density 2.39 g/cm³.
b) Carbon nanofibres, with diameters in the order of 20-80 nm and density 1.97 g/cm³.
c) Alumina powder with average particle size less than 160 nm and density 3.93 g/cm³.
d) Anhydrous ethanol (99.97% purity)

250 g of LAS were used which were dispersed in 800 g of ethanol. It is then mixed with a suspension of 104.6 g of carbon nanofibres in 1300 g of ethanol and a suspension of 411.2 g of Al₂O₃ in 1000 g of ethanol. The combination is homogenized by mechanical stirring during 60 minutes and is then milled in an attrition mill operating at 300 r.p.m. during a further 60 minutes. The suspension thus prepared is dried by atomization, obtaining nanocomposite granules whist recovering the ethanol from the process.

The dry product thus obtained was subjected to a forming and sintering process using Spark Plasma Sintering (SPS). For this, 18.4 grams of the material were introduced in a graphite mould with a diameter of 40 mm and it is uniaxially pressed at 10 MPa. Next, the sintering is carried out by applying a maximum pressure of 80 MPa, with heating ramp of 100° C./min to 1250° C. and 1 minutes' stay.

The resulting material was characterized by its real density (helium pycnometry), apparent density (Archimedes' method), Young's modulus (resonance frequency method in a Grindosonic unit), resistance to fracture (four point bending method in an INSTRON 8562 unit), and coefficient of thermal expansion (dilatometer, make: NETZCH, model: DIL402C). The corresponding values appear in Table 4. The variation of the coefficient of thermal expansion with the temperature is represented in FIG. 2.

TABLE 4
Results obtained from the characterization of the composite
material of LAS and carbon nanofibres, sintering using
Spark Plasma Sintering (SPS).

| Property | Ex. 4 |
|---|---|
| % Theoretical density | 98.9 |
| 100 × (dₐₚₚₐᵣₑₙₜ/dᵣₑₐₗ) | |
| Resistance to fracture (MPa) | 310 |
| CTE(×10⁻⁶ K⁻¹) (−150, 150) ° C. | 2.83 |
| CTE(×10⁻⁶ K⁻¹) (−150, 450) ° C. | 3.88 |

1. A material comprising:
a ceramic component, and
carbon nanofilaments,
where said material is characterized in that it has a coefficient of thermal expansion between −6×10⁻⁶° C.⁻¹ and 6.01×10⁻⁶° C.⁻¹.

2. The material according to claim 1, wherein it further contains an oxidic or non-oxidic ceramic in a volume percent less than 80%.

3. The material according to claim 1, wherein the ceramic component is selected from Li₂O:Al₂O₃:SiO₂ or MgO:Al₂O₃:SiO₂.

4. The material according to claim 3, wherein the ceramic component is β-eucryptite or cordierite.

5. The material according to claim 1, wherein the ceramic component has a volume percent with respect to the end material, greater than 10%.

6. The material according to claim 1, wherein the carbon nanofilaments are carbon nanofibres.

7. The material according to claim 6, wherein the carbon nanofibres, have a diameter between 20 and 80 nm.

8. The material according to claim 6, wherein the carbon nanofibres have a length/diameter ratio greater than 100.

9. The material according to claim 6, wherein the carbon nanofibres have a graphic structure greater than 70%.

10. The material according to claim 2, wherein the oxidic or non-oxidic ceramic is selected from carbides, nitrides, borides, oxides of metal or any of their combinations.

11. The material according to claim 10, wherein the oxidic or non-oxidic ceramic is selected from the list comprising: SiC, TiC, AlN, Si₃N₄, TiB₂, Al₂O₃, ZrO₂ and MgAl₂O₄.

12. The material according to claim 11, wherein the oxidic ceramic is Al₂O₃.

13. The material according to claim 12, wherein the Al₂O₃ has a grain size between 20 and 1000 nm.

14. The material according to claim 11, wherein the non-oxidic ceramic is SiC.

15. The material according to claim 14, wherein the SiC has a grain size less than 10 μm.

16. A process comprising the stages:
a. mixing of a ceramic component with the nanofilaments in a solvent,
b. drying of a mixture obtained in (a),
c. forming of a material obtained in (b) where said material is characterized in that it has a coefficient of thermal expansion between −6×10⁻⁶° C.⁻¹ and 6.01×10⁻⁶° C.⁻¹,
d. sintering of a material obtained in (c).

17. The process according to claim 16, wherein an oxidic or non-oxidic ceramic is further added in stage (a).

18. The process according to claim 16, wherein the solvent is selected from water, anhydrous alcohol or any of the combinations.

19. The process according to claim 18, wherein the anhydrous alcohol, is anhydrous ethanol.

20. The process according to claim 16, wherein the mixing of stage (a) is performed between 100 and 400 r.p.m.

21. The process according to claim 16, wherein the drying of stage (b) is performed by atomization.

22. The process according to claim 16, wherein the forming of stage (c) is performed by cold or hot isostatic pressing.

23. The process according to claim 22, wherein the cold isostatic pressing is performed at pressures between 100 and 400 MPa.

24. The process according to claim 22, wherein the hot pressing is performed by applying a uniaxial stress between 5 and 150 MPa, at a temperature between 900 and 1600° C., with a heating ramp between 2 and 50° C./min, remaining at this temperature for 0.5 a 10 hours.

25. The process according to claim 16, wherein the sintering of stage (d) is performed at temperatures between 700 and 1600° C.

26. The process according to claim 25, wherein stage (d) of sintering is performed without the application of pressure or applying uniaxial pressure.

27. The process according to claim 25, wherein the sintering is performed in inert atmosphere at a temperature between 1100 and 1600° C., with a heating ramp between 2 and 10° C./min, remaining at this temperature for 0.5 and 10 hours.

28. The process according to claim 27, wherein the inert atmosphere is of argon.

29. The process according to claim 27, wherein subsequent cooling to 900° C. is performed using a ramp of between 2 and 10° C./min.

30. The process according to claim 25, wherein the sintering is performed by applying a uniaxial pressure between 5 and 150 MPa, at a temperature between 700 and 1600° C., with a heating ramp of between 2 and 300° C./min, remaining at this temperature for a period between 1 and 30 min.

31. An electrical conductor or ceramic component comprising the material according to claim 1.

32. (cancel)
